(19) United States
(12) Patent Application Publication
(10) Pub. No.: US 2026/0220629 A1
(43) Pub. Date: Jul. 30, 2026

(54) AUTHORIZATION SYSTEM AND METHOD, STORAGE MEDIUM, AND COMPUTER SYSTEM

(71) Applicant: Advanced Nova Technologies (Singapore) Holding Pte. Ltd., Singapore (SG)

(72) Inventor: Yu YANG, Hangzhou (CN)

(73) Assignee: Advanced Nova Technologies (Singapore) Holding Pte. Ltd., Singapore (SG)

(21) Appl. No.: 19/437,968

(22) Filed: Dec. 31, 2025

(30) Foreign Application Priority Data
Jan. 24, 2025 (SG) 10202500227V

(51) Int. Cl. G06Q 20/36; G06Q 20/32; G06Q 20/40; H04L 9/40

(52) U.S. Cl. CPC G06Q 20/3674; G06Q 20/3255; G06Q 20/40145; G06Q 20/4016; H04L 63/083; H04L 63/10

(57) ABSTRACT

An authorization method includes starting, by a service client in a user terminal in an authorization system, an acquiring institution software package in response to an authorization request of a user, where the service client is installed in the user terminal, and where the service client comprises the acquiring institution software package. Risk control data of the service client is obtained by the acquiring institution software package. The risk control data is sent to an electronic wallet server through an acquiring institution server, where the electronic wallet server determines a risk level of the authorization request based on the risk control data and sends the risk level to the acquiring institution software package through the acquiring institution server. The acquiring institution software package receives the risk level. An authorization procedure corresponding to the risk level is executed.

### CROSS-REFERENCE TO RELATED APPLICATIONS

This application claims priority to Singapore Patent Application No. 10202500227V, filed on January 24, 2025, which is hereby incorporated by reference in its entirety.

### TECHNICAL FIELD

This specification relates to the field of computer technologies, and in particular, to an authorization system and method, a storage medium, and a computer system.

### BACKGROUND

With rapid development of Internet technologies, there are more application scenarios of online payment. Withholding is a current common convenient payment mode.

Before a user performs payment in the convenient payment mode of withholding on a service client, the user needs to authorize the service client and an electronic wallet, and then bind an account of the user in the service client and an account of the electronic wallet. Subsequently, when payment needs to be performed for a service request initiated by the service client, the service client can directly initiate a deduction request for the bound account of the electronic wallet account, without obtaining further confirmation of the user. Usually, the service client is integrated with an acquiring institution software package (Software Development Kit, SDK), and a user identity is authenticated through interaction between an acquiring institution and an electronic wallet, to complete authorization.

However, in the conventional technology, an authorization manner in which an authorization service is executed is not flexible enough, and user experience is poor. Therefore, this specification provides an authorization system.

### SUMMARY

Embodiments of this specification provide an authorization system and method, a storage medium, and a computer system, to partially resolve the above-mentioned problem in the conventional technology.

This specification provides an authorization system. The system includes a user terminal, an acquiring institution server, and an electronic wallet server, a service client is installed in the user terminal, and the service client includes an acquiring institution software package. The service client in the user terminal starts the acquiring institution software package in response to an authorization request of a user. The acquiring institution software package obtains risk control data of the service client, and sends the risk control data to the electronic wallet server through the acquiring institution server. The electronic wallet server determines a risk level of the authorization request based on the risk control data; executes an authorization procedure corresponding to the risk level; and sends the risk level to the acquiring institution software package through the acquiring institution server. The acquiring institution software package receives the risk level, and executes the authorization procedure corresponding to the risk level.

This specification provides an authorization method, applied to a user terminal in an authorization system. The authorization system includes the user terminal, an acquiring institution server, and an electronic wallet server, a service client is installed in the user terminal, the service client includes an acquiring institution software package, and the method includes: The service client in the user terminal starts the acquiring institution software package in response to an authorization request of a user. The acquiring institution software package obtains risk control data of the service client, and sends the risk control data to the electronic wallet server through the acquiring institution server. The electronic wallet server determines a risk level of the authorization request based on the risk control data, and sends the risk level to the acquiring institution software package through the acquiring institution server. The acquiring institution software package receives the risk level sent by the acquiring institution server, and executes the authorization procedure corresponding to the risk level.

This specification provides an authorization method, applied to an electronic wallet server in an authorization system. The authorization system includes a user terminal, an acquiring institution server, and the electronic wallet server, a service client is installed in the user terminal, the service client includes an acquiring institution software package, and the method includes: receiving risk control data of the service client, where the risk control data is obtained in response to an authorization request of a user; determining a risk level of the authorization request based on the risk control data; and executing an authorization procedure corresponding to the risk level, and sending the risk level to the acquiring institution software package through the acquiring institution server, so that the acquiring institution software package executes the authorization procedure corresponding to the risk level.

This specification provides a computer system. The computer system serves as a user terminal in an authorization system, the authorization system includes the user terminal, an acquiring institution server, and an electronic wallet server, a service client is installed in the user terminal, and the service client includes an acquiring institution software package. The computer system includes a storage, a processor, and a computer program that is stored in the storage and that is capable of running on the processor, where when executing the program, the processor implements the following steps: The service client in the user terminal starts the acquiring institution software package in response to an authorization request of a user. The acquiring institution software package obtains risk control data of the service client, and sends the risk control data to the electronic wallet server through the acquiring institution server. The electronic wallet server determines a risk level of the authorization request based on the risk control data, and sends the risk level to the acquiring institution software package through the acquiring institution server. The acquiring institution software package receives the risk level sent by the acquiring institution server, and executes the authorization procedure corresponding to the risk level.

This specification provides a computer system. The computer system is applied to an electronic wallet server in an authorization system, the authorization system includes a user terminal, an acquiring institution server, and the electronic wallet server, a service client is installed in the user terminal, and the service client includes an acquiring institution software package. The computer system includes a storage, a processor, and a computer program that is stored in the storage and that is capable of running on the processor, where when executing the program, the processor implements the following steps: receiving risk control data of the service client, where the risk control data is obtained in response to an authorization request of a user; determining a risk level of the authorization request based on the risk control data; and executing an authorization procedure corresponding to the risk level, and sending the risk level to the acquiring institution software package through the acquiring institution server, so that the acquiring institution software package executes the authorization procedure corresponding to the risk level.

This specification provides a computer-readable nonvolatile storage medium. The storage medium stores a computer program, and when the computer program is executed by a processor, the above-mentioned authorization method is implemented.

The above-mentioned at least one technical solution used in the embodiments of this specification can achieve at least one of the following beneficial effects: The authorization system provided in this specification can flexibly select different authorization procedures based on different risk levels determined by the electronic wallet server, to improve user experience.

### BRIEF DESCRIPTION OF DRAWINGS

The accompanying drawings described herein are used to provide a further understanding of this specification and constitute a part of this specification. The example embodiments of this specification and descriptions thereof are used to explain this specification, and do not constitute an improper limitation on this specification. In the accompanying drawings:

FIG. 1 is a schematic diagram of an interaction procedure of an authorization system according to this specification;

FIG. 2 is a schematic diagram of an interaction procedure of an authentication process according to this specification;

FIG. 3 is a schematic diagram of an interaction procedure of an authorization system according to this specification;

FIG. 4 is a diagram of a page display process existing when a risk level is not less than a preset level according to an embodiment of this specification;

FIG. 5 is a diagram of an interaction procedure of intra-end authorization according to this specification;

FIG. 6 is a diagram of a page display process existing when a risk level is less than a preset level according to an embodiment of this specification;

FIG. 7 is a schematic flowchart of an authorization method according to this specification;

FIG. 8 is a schematic flowchart of an authorization method according to this specification; and

FIG. 9 is a schematic structural diagram of a computer system according to this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of embodiments of this specification. All other embodiments obtained by a person of ordinary skill in the art based on the embodiment of this specification without creative efforts shall fall within the protection scope of this specification.

Withholding simplifies an operation procedure in a user payment process, but also reduces an authentication process. To protect property security of a user, a service client and an electronic wallet need be authorized when the user uses a fast payment mode of withholding for payment. Such an authorization service binds a service client account of the user and an electronic wallet account of the user; when payment needs to be performed for a service request initiated by the user, authorizes the service client to send a deduction request to an electronic wallet server based on a payment amount corresponding to the service request; and authorizes the electronic wallet to directly deduct, from the electronic wallet account of the user based on the deduction request sent by the service client, an amount specified by the deduction request, without re-authenticating a user identity.

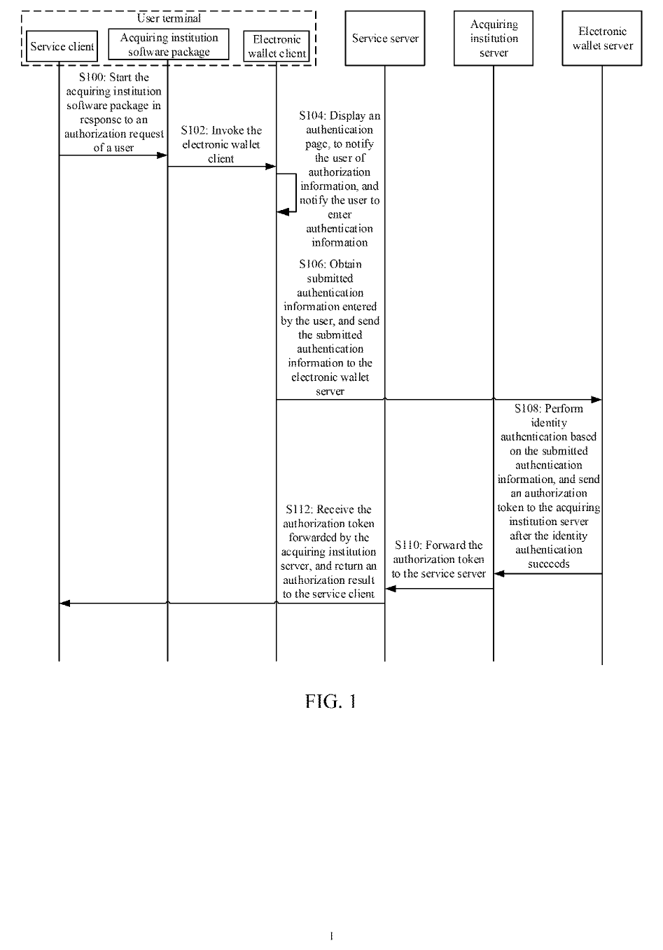

Currently, a single authorization manner is used in an authorization system that executes an authorization service. FIG. 1 is a schematic diagram of an interaction procedure of an authorization system according to this specification. The following describes an interaction procedure of the authorization system in a single authorization manner by using FIG. 1. As shown in FIG. 1, the authorization system includes a user terminal, a service server, an acquiring institution server, and an electronic wallet server. A service client and an electronic wallet client are installed in the user terminal, and the service client includes an acquiring institution software package. The service client is a client that provides one or more Internet services, and the Internet service can be shopping, taking a taxi, a movie, etc.

S100: The service client in the user terminal starts the acquiring institution software package in response to an authorization request of a user.

When the user wants to use withholding for payment in the service client, the user needs to first send the authorization request to the service client. In response to the authorization request of the user, the service client starts the acquiring institution software package, and executes the authorization service.

The authorization request is usually initiated in two scenarios: a separate authorization scenario and a payment authorization scenario.

In the separate authorization scenario, the user initiates the authorization request when the user initiates no order payment request in the service client. In this case, the service client executes the authorization service in response to the authorization request of the user. After it is determined that the authorization service is successfully executed, the user initiates an order payment request in the service client. The service client sends a deduction request to the electronic wallet server based on an amount corresponding to the order payment request. The electronic wallet server deducts the amount corresponding to the order payment request from an electronic wallet account of the user based on the deduction request. Such a payment service is completed.

In the payment authorization scenario, when the user initiates the order payment request in the service client, the service client displays a payment manner option to the user in response to the order payment request. The payment manner option includes payment manners such as withholding payment, electronic wallet payment password authentication payment, and bank card payment. Withholding cannot be used for payment when the user does grant authorization. Therefore, if the user chooses to use withholding payment, the service client is triggered to perform an authorization intent confirmation operation. The service client displays an intent confirmation page, to query the user about whether to initiate the authorization request. If the user chooses to initiate the authorization request, the authorization request is formally initiated. In this case, the service client executes the authorization service in response to the authorization request of the user, and executes the payment service through withholding payment after determining that the authorization service is successfully executed.

Then, when the user initiates the order payment request in the service client, the service client does not display the payment manner option to the user, and directly executes the payment service through withholding payment based on the authorization request. If the user subsequently does not want use withholding payment for payment, the service client or the electronic wallet client can initiate a withholding service disabling request.

S102: The acquiring institution software package invokes the electronic wallet client.

The acquiring institution software package obtains a current account of the user in the service client, and uses the current account as a first authorization account; and sends an invoking request to the electronic wallet client. The invoking request includes the first authorization account.

The electronic wallet client can be in a plurality of forms, and can be an independent electronic wallet app, or can be a browser.

If an electronic wallet app is installed on the user terminal, the electronic wallet app is the electronic wallet client, and the acquiring institution software package invokes the electronic wallet app. If no electronic wallet app is installed on the user terminal, the acquiring institution software package invokes a browser on the user terminal. If neither an electronic wallet app nor a browser is installed on the user terminal, the acquiring institution software package displays a prompt page to the user, to notify the user to install an electronic wallet app. After installing the electronic wallet app, the user continues to execute the authorization service.

S104: The electronic wallet client displays an authentication page, to notify the user of authorization information, and notify the user to enter authentication information.

After receiving the invoking request, the electronic wallet client obtains a current login account of the electronic wallet client, and uses the current login account as a second authorization account.

Specifically, if the electronic wallet client is in a login state, after receiving the invoking request, the electronic wallet client determines that an electronic wallet account currently logged in to by the user is used as the second authorization account. If the electronic wallet client is in a non-login state, after receiving the invoking request, the electronic wallet client displays a login page, to notify the user to perform a login operation. After the user logs in successfully, it is determined that the electronic wallet account currently logged in to by the user is used as the second authorization account.

Then, the electronic wallet client determines authorization information based on the first authorization account and the second authorization account. The authorization information indicates that the first authorization account and the second authorization account are to be bound. The electronic wallet client sends the authorization information to the electronic wallet server, renders the authentication page based on the authorization information, and displays the authentication page to the user. The authentication page is used to notify the user of the authorization information and notify the user to enter the authentication information.

The authentication page can be one page that is used to notify the user of the authorization information and notify the user to enter the authentication information. Alternatively, the authentication page can be two pages. On a first page, the user is notified of the authorization information, and on the second page, the user is notified to enter the authentication information.

S106: The electronic wallet client obtains submitted authentication information entered by the user, and sends the submitted authentication information to the electronic wallet server.

The electronic wallet client sends the submitted authentication information to the electronic wallet server, and the electronic wallet server performs identity authentication on the user based on the submitted authentication information.

S108: The electronic wallet server performs identity authentication based on the submitted authentication information, and sends an authorization token to the acquiring institution server after the identity authentication succeeds.

The electronic wallet server determines original authentication information corresponding to the second authorization account based on the received authorization information. After the submitted authentication information is received, the submitted authentication information and the original authentication information are compared. If a comparison result is that the submitted authentication information and the original authentication information are consistent, authentication succeeds, and the authorization token is sent to the acquiring institution server. If a comparison result is that the submitted authentication information and the original authentication information are inconsistent, authentication fails, the authorization service is terminated, and it is indicated that the authorization service has a risk.

In the authorization service, to further ensure service security, the electronic wallet server not only needs to perform identity authentication on the user, but also needs to perform identity authentication on the acquiring institution server. After two times of identity authentication succeed, the electronic wallet server sends the authorization token to the acquiring institution server.

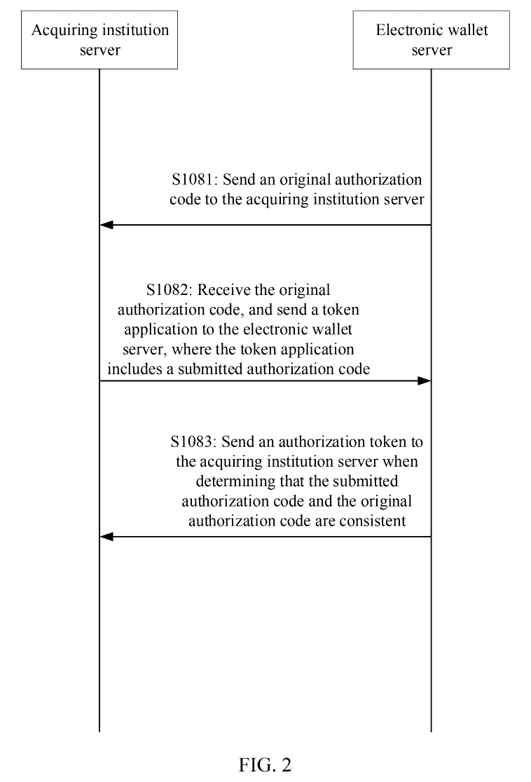

FIG. 2 is a schematic diagram of an interaction procedure of an authentication process according to this specification. Based on FIG. 2, step S108 can further include the following steps.

S1081: The electronic wallet server sends an original authorization code to the acquiring institution server.

S1082: The acquiring institution server receives the original authorization code, and sends the token application to the electronic wallet server, where the token application includes a submitted authorization code.

S1083: The electronic wallet server sends the authorization token to the acquiring institution server when determining that the submitted authorization code and the original authorization code are consistent.

The electronic wallet server performs identity authentication on the acquiring institution server based on the submitted authorization code in the token application. The electronic wallet server compares the submitted authorization code in the received token application and the original authorization code. If a comparison result is that the submitted authorization code in the received token application and the original authorization code are consistent, it indicates that identity authentication performed by the electronic wallet server on the acquiring institution server succeeds, and the electronic wallet server sends the authorization token to the acquiring institution server.

The acquiring institution server obtains the authorization token sent by the electronic wallet server, which represents that an authorization result of the authorization service is a success.

After determining that the submitted authentication information and the original authentication information are consistent, the electronic wallet server interacts with the acquiring institution server according to steps of S1081 to S1083, and sends the authorization token to the acquiring institution server in a state in which it is ensured that the acquiring institution server is secure.

S110: The acquiring institution server forwards the authorization token to the service server.

S112: The service server receives the authorization token forwarded by the acquiring institution server, and returns the authorization result to the service client.

The acquiring institution server sends the obtained authorization token to the service server. The authorization token is a credential indicating that the service server obtains authorization from the user.

After the service server receives the authorization token, a background interaction procedure of the authorization service is successfully completed. The service server sends the authorization result to the service client, and the service client displays the authorization result to the user.

In the authorization system shown in FIG. 1, collection of authentication information required for authenticating a user identity is completed by the electronic wallet client. Because the user initiates the authorization request in the service client, when the electronic wallet client collects the authentication information, a user interface jumps from the service client to the electronic wallet client. A jump between different clients causes poor user experience. In addition, a jump between clients is limited by a network environment. When the network environment is poor, the jump between clients cannot be completed, and the authorization request of the user is forcibly interrupted, thereby reducing a success rate of the authorization service.

This specification aims to provide an authorization system, to flexibly select different authorization manners based on a risk level of an authorization request of a user.

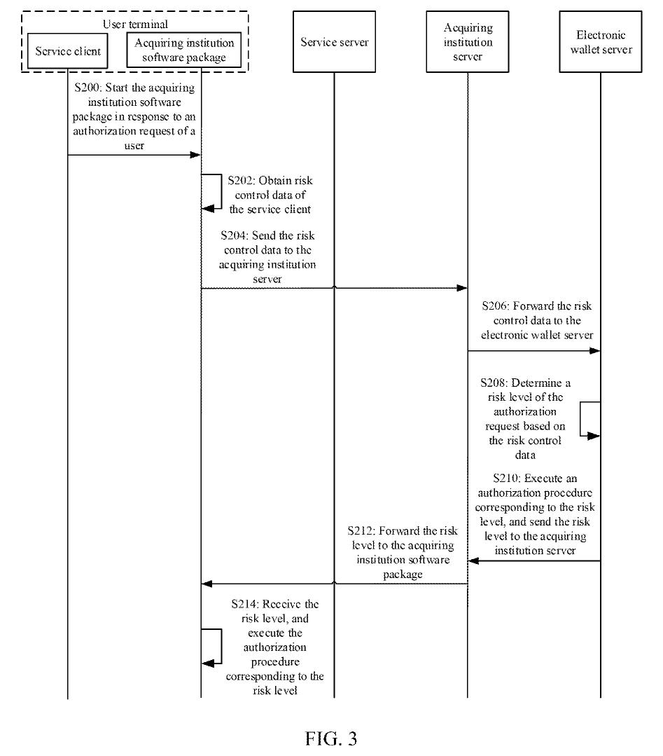

FIG. 3 is a schematic diagram of an interaction procedure of an authorization system according to this specification. The authorization system includes a user terminal, a service server, an acquiring institution server, and an electronic wallet server. A service client is installed in the user terminal, and the service client includes an acquiring institution software package. The interaction procedure of the authorization system shown in FIG. 3 can include the following steps.

S200: The service client in the user terminal starts the acquiring institution software package in response to an authorization request of a user.

This step is the same as step S100 shown in FIG. 1. For specific content, refer to descriptions of corresponding content in step S100. Details are not described herein again in this specification.

S202: The acquiring institution software package obtains risk control data of the service client.

The acquiring institution software package obtains a current account of the user in the service client, and uses the current account as a first authorization account; and in response to the authorization request, collects information to obtain first user information of the first authorization account and first device information of the user terminal, and uses the first user information and the first device information as the risk control data of the service client.

The first user information is all user attribute information corresponding to the first authorization account, and includes user attribute information corresponding to user attributes such as a mobile number, an email address, and a name that are submitted in a process in which the user registers with and uses the first authorization account in the service client. Each piece of user attribute information includes a user attribute and an attribute value of the user attribute. For example, one piece of user attribute information is "mobile number: 123456", and indicates that a user attribute represented by the user attribute information is "mobile number" and an attribute value is "123456".

The first device information is all device attribute information of a current user terminal. Device attribute information of a device is an identifier of the device, and can be used to identify the device. A device attribute includes different information types such as hardware information, software information, network information, and behavior information. Each information type includes different device attributes. For example, the hardware information includes device attributes such as a mainboard model, a graphics card model, and a screen resolution, the software information includes device attributes such as an operating system version, a browser version, and an installed application list, the network information includes device attributes such as an internet protocol (IP) address, a media access control (MAC) address, and a service set identifier (SSID), and the behavior information includes device attributes such as a login time and a login frequency.

In this specification, a type of the device attribute information included in the first device information is not limited, and device attribute information of the one or more information types can be selected as the first device information based on a requirement of an actual authorization service scenario. That is, the first device information can include all device attribute information corresponding to only the hardware information, or can include all device attribute information corresponding to the hardware information and the network information, or include all device attribute information corresponding to the hardware information, the software information, the network information, and the behavior information, etc.

Each piece of device attribute information includes a device attribute and an attribute value of the device attribute. For example, if one piece of device attribute information is "IP address: 123.124.125.1", it indicates that a user attribute represented by the user attribute information is "IP address" and an attribute value is "123.124.125.1".

The acquiring institution software package needs to send the risk control data of the service client to the acquiring institution server, and then the acquiring institution server sends the risk control data to the electronic wallet server, to perform risk identification on a service environment of the authorization request.

S204: The acquiring institution software package sends the risk control data to the acquiring institution server.

S206: The acquiring institution server forwards the risk control data to the electronic wallet server.

S208: The electronic wallet server determines a risk level of the authorization request based on the risk control data.

The electronic wallet server stores user data and a device login record of each electronic wallet user. The user data is user attribute information corresponding to each electronic wallet account, and includes user attribute information corresponding to user attributes such as a mobile number, an email address, a name, and a bank card number that are submitted in a process in which the user registers with and uses the electronic wallet client.

The device login record is device attribute information of a historical login device corresponding to each electronic wallet account, and records device attribute information of a device used in each time of historical login of each electronic wallet account. The device login record can be stored in different forms in the electronic wallet server. For example, the login time can be used as an index for storage. In this case, each login behavior corresponds to one login record. The login record includes device attribute information of a device used in a current time of login. The login device can also be used as an index for storage. In this case, different devices correspond to one login record. The login record records device attribute information of all times of login in the device.

The electronic wallet server performs risk identification on the service environment of the authorization request based on the first user information, the first device information, the user data of the electronic wallet, and the device login record of the electronic wallet, to determine the risk level of the authorization request. A specific manner of obtaining the risk level through division is not limited in this specification. A quantity of risk levels obtained through division can be determined based on an actual situation.

The authorization system in this specification provides two optional authorization procedures. The electronic wallet server classifies the risk levels into two types by using a preset level as a boundary. If a risk level is less than the preset level, the risk level is a low risk, and if a risk level is not less than the preset level, the risk level is a high risk. The high risk and the low risk correspond to different authorization procedures. Therefore, authorization procedures corresponding to different risk levels are not exactly the same.

In one or more embodiments of this specification, the electronic wallet server determines the risk level by analyzing a device login record of the same user.

The first user information is user information corresponding to the first authorization account. If an electronic wallet account to be bound with the user in the authorization request belongs to the user, the first user information and the second user information need to be highly consistent.

First, the electronic wallet server determines, in the user data of the electronic wallet, the second user information that matches the first user information, and uses an electronic wallet account corresponding to the second user information as a target account.

The first user information is collected by the acquiring institution software package, and is used to identify the risk level of the authorization request. Each user attribute included in the first user information can correspond to one user attribute in user attribute information of each electronic wallet account.

For each user attribute, the electronic wallet server uses an attribute value of the user attribute in the first user information as a standard value, and determines, as a matched value, an attribute value the same as the standard value in attribute values of the user attribute that correspond to all electronic wallet accounts included in the user data of the electronic wallet. Each piece of user attribute information of an electronic wallet account to which the matched value belongs is second user information.

Because the same user may have a plurality of electronic wallet accounts, each matched value may belong a plurality of electronic wallet accounts. If electronic wallet accounts to which all matched values belong are the same account, the electronic wallet account is the target account. If electronic wallet accounts to which all matched values belong are different accounts, an electronic wallet account corresponding to most matched values is used as the target accounts.

In this embodiment, when the electronic wallet accounts to which all the matched values belong are different accounts, a case in which quantities of matched values corresponding to two electronic wallet accounts are equally the highest usually does not occur, because at least one piece of user attribute information in all user attribute information corresponding to one account is registration credential information. A user attribute corresponding to the registration credential information is unique. When registering an account, the user needs to submit the registration credential information. The registration credential information is a unique identifier of the account. Common registration credential information includes mobile number information, email address information, etc.

For example, in a scenario, for both the service client and the electronic wallet client, the mobile number information is used as registration credential information. First user information corresponding to a service client account that needs to be bound with the user in the authorization request includes a target mobile number. If the user has a plurality of electronic wallet accounts, an electronic wallet account that is registered by using the target mobile number as registration credential information usually exists in the electronic wallet accounts. Because all the electronic wallet accounts belong to the user, user attribute information corresponding to the electronic wallet accounts other than the registration credential information is likely to be consistent.

However, the electronic wallet account that is registered by using the target mobile number as registration credential information is an electronic wallet account that has most matched values with the first user information, because the target mobile number is used as registration credential information for both the two accounts. Even if the user attribute information corresponding to the electronic wallet accounts other than the registration credential information is consistent with user attribute information included in the first user information, the target account can be determined based on mobile number attribute information. Because an attribute value of a mobile number attribute corresponding to the target account is consistent with an attribute value of a mobile number attribute included in the first user information, an attribute value of a mobile number attribute corresponding to a non-target account in the electronic wallet accounts is inconsistent with the attribute value of the mobile number attribute included in the first user information.

Then, the electronic wallet server determines reference device information corresponding to the target account from the device login record of the electronic wallet; and matches the first device information with the reference device information, to determine a first matching degree, and determines the risk level of the authorization request based on the first matching degree.

The reference device information is device attribute information of a historical login device of the target account. Because the target account may be logged in to in only one device or may be logged in to in a plurality of devices, the reference device information can include device attribute information of one or more devices.

Specifically, the electronic wallet server matches the first device information with the reference device information, to determine the first matching degree, and determines, based on a correspondence between a preset matching degree interval and each risk level, that a risk level corresponding to an interval of the first matching degree is the risk level of the authorization request. A quantity of matching degree intervals is the same as a quantity of risk levels obtained through division, and each interval corresponds to one risk level. A higher first matching degree indicates a lower risk level of the authorization request.

The electronic wallet server determines whether the risk level is less than the preset level. If yes, it indicates that an overlapping degree between the first device information and the reference device information is high, which indicates that a current device is a common device for logging in to the target account, the service environment of the authorization request is secure, and an authorization procedure corresponding to the low risk can be executed. If no, it indicates that an overlapping degree between the first device information and the reference device information is low, which indicates that a current device is not a common device for logging in to the target account, the service environment of the authorization request is abnormal, and an authorization procedure corresponding to the low risk can be executed.

To improve identification efficiency of the risk level, the electronic wallet server can first determine a risk index of the target account based on a preset risk control rule and the reference device information before determining the first matching degree. If the risk index is greater than a preset risk threshold, it indicates that the target account has a risk, and the electronic wallet server can directly determine that the authorization request has a high risk, and does not determine a specific risk level, that is, does not perform a subsequent step of determining the first matching degree.

The risk control rule can be based on a login time, a login frequency, a login IP address, etc., and can be formulated based on an actual authorization service scenario. For example, there is a risk behavior when a login frequency is greater than a preset value within a preset time period, there is a risk behavior when a login time is inconsistent with a customary login time, and there is a risk behavior when a login IP address is inconsistent with a common IP address.

Specifically, the electronic wallet server can determine a determining result of each risk behavior based on the risk control rule. That is, if it is determined that a risk behavior exists in the target account, a determining result of the risk behavior is "1"; otherwise, a determining result of the risk behavior is "0".

The electronic wallet server can determine a weight value of each risk behavior by using a preset risk control model, and determine the risk index of the target account based on a weighted sum of the determining result of each risk behavior and the weight value corresponding to each risk behavior.

In one or more embodiments of this specification, the electronic wallet server determines the risk level by analyzing a historical login user of the same device.

The first device information is device attribute information of the current device. If the electronic wallet account to be bound with the user in the authorization request is historically logged in to in the current device, device attribute information of the current device exists in the device login record of the electronic wallet.

First, the electronic wallet server determines the second device information matching the first device information from the device login record of the electronic wallet.

Each device attribute included in the first device information can correspond to one device attribute of a historical login device corresponding to each electronic wallet account.

For each device attribute, the electronic wallet server uses an attribute value of the device attribute in the first device information as a standard value, and determines, as a matched value, an attribute value the same as the standard value in attribute values of the device attribute that correspond to all electronic wallet accounts included in the device login record of the electronic wallet. Each piece of device attribute information of an electronic wallet account to which the matched value belongs is second device information.

Then, the electronic wallet server determines an electronic wallet account corresponding to the second device information in the device login record as a reference account, and determines reference user information based on the reference account.

Both the first device information and the second device information are device attribute information of the current device. The electronic wallet server determines, in the device login record of the electronic wallet, that an electronic wallet account that is historical logged in to in the current device is a reference account; and determines, in the user data of the electronic wallet, that user attribute information corresponding to the reference account is reference user information.

Because there may be one or more electronic wallet accounts that are historical logged in to in the current device, the reference account may include one electronic wallet account or may include a plurality of electronic wallet accounts, that is, the reference user information is user attribute information of one or more electronic wallet accounts.

Finally, the electronic wallet server matches the first user information with the reference user information, to determine a second matching degree, and determines the risk level of the authorization request based on the second matching degree.

Specifically, the electronic wallet server matches the first user information with the reference user information, to determine the second matching degree, and determines, based on a correspondence between a preset matching degree interval and each risk level, that a risk level corresponding to an interval of the second matching degree is the risk level of the authorization request. A quantity of matching degree intervals is the same as a quantity of risk levels obtained through division, and each interval corresponds to one risk level. A higher second matching degree indicates a lower risk level of the authorization request.

The electronic wallet server determines whether the risk level is less than the preset level. If yes, it indicates that an overlapping degree between the first user information and the reference user information is high, which indicates that the user is a frequent user who logs in to the electronic wallet client by using the current device. It can be considered that the current device is a common device in which the user logs in to the electronic wallet client, that is, an environment of a current authorization service is secure, and the authorization procedure corresponding to the low risk can be executed. If no, it indicates that an overlapping degree between the first user information and the reference user information is low, which indicates that the user is not a frequent user who logs in to the electronic wallet client by using the current device, the current device is most likely not a common device in which the user logs in to the electronic wallet client, an environment of the authorization service is abnormal, and the authorization procedure corresponding to the high risk can be executed.

A quantity of electronic wallet accounts logged in to in a device can reflect security of the device to some extent. Therefore, the electronic wallet server can further perform a preliminary evaluation on the risk level of the authorization request in advance based on a quantity of reference accounts, to determine an initial level. When the initial level is high, a specific risk level is no longer determined, that is, a subsequent step of determining the second matching degree is not performed, and it is directly determined that the authorization request has a high risk, to simplify a process of determining the risk level and improve execution efficiency of the authorization system.

Specifically, the electronic wallet server determines whether the quantity of reference accounts is greater than a preset security threshold. If yes, it is determined that the initial level is high. If no, it is determined that the initial level is low.

In the above-mentioned two embodiments for determining the risk level, the electronic wallet server can execute any one of the above-mentioned two embodiments, or can simultaneously execute the above-mentioned two embodiments, and comprehensively determine the risk level based on the first matching degree and the second matching degree.

S210: The electronic wallet server executes an authorization procedure corresponding to the risk level, and sends the risk level to the acquiring institution server.

In the authorization system provided in this specification, different risk levels correspond to different authorization procedures. The authorization procedure needs to be completed through interaction between the electronic wallet server and the acquiring institution software package. Therefore, after determining the risk level, the electronic wallet server sends the risk level to the acquiring institution server.

S212: The acquiring institution server forwards the risk level to the acquiring institution software package.

S214: The acquiring institution software package receives the risk level, and executes the authorization procedure corresponding to the risk level.

The authorization system provided in this specification can flexibly select the authorization procedure based on the risk level determined by the electronic wallet server, to improve user experience.

When the risk level is not less than the preset level, the electronic wallet server cooperates with the acquiring institution software to execute the authorization service in a pull-end authorization manner according to steps S102 to S112.

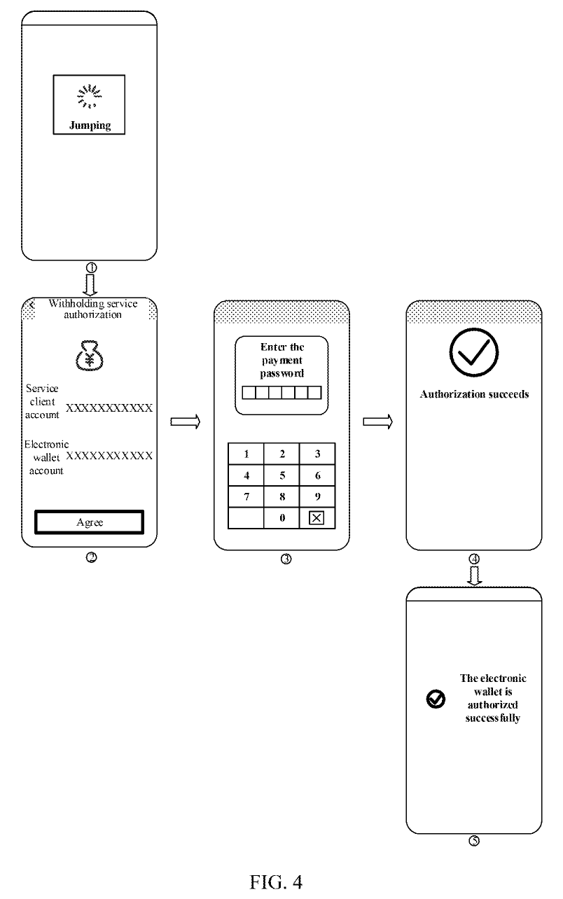

FIG. 4 is a diagram of a page display process existing when a risk level is not less than a preset level according to an embodiment of this specification. The process shown in FIG. 4 includes a total of five pages: a page ① to a page ⑤. Pages (① and ⑤) on which top columns are blank are service client display pages, and pages (② to ④) on which top columns are shaded are electronic wallet client display pages.

As shown in FIG. 4, after the user initiates the authorization request in the service client, the authorization system performs steps S200 to S208, and executes the authorization procedure corresponding to the high risk when determining that the risk level is not less than the preset level. The service client displays the page ①, to notify the user that the page is to jump. Then, the electronic wallet client displays the page ②. This page ② is the first authentication page, and the authorization information is displayed to the user, to request the user to determine whether to bind the first authorization account of the service client and the second authorization account of the electronic wallet. If the user agrees to bind the first authorization account and the second authorization account, the electronic wallet client displays the page ③. This page is the second authentication page, and notifies the user to enter the authentication information. The electronic wallet client sends the submitted authentication information entered by the user to the electronic wallet server for identity authentication.

After authentication succeeds, the electronic wallet server interacts with the acquiring institution server according to steps S106 to S108. After the acquiring institution server obtains the authorization token provided by the electronic wallet server, authorization succeeds. The electronic wallet server notifies the electronic wallet client of an authorization success result. The electronic wallet client displays the page ④. The electronic wallet client notifies the user of the authorization result. In addition, after obtaining the access token, the acquiring institution server notifies the service client of the authorization result. The service client displays the page ⑤, and the service client notifies the user of the authorization result.

When the risk level is less than the preset level, the electronic wallet server cooperates with the acquiring institution software package to execute the authorization procedure corresponding to the low risk in an intra-end authorization manner.

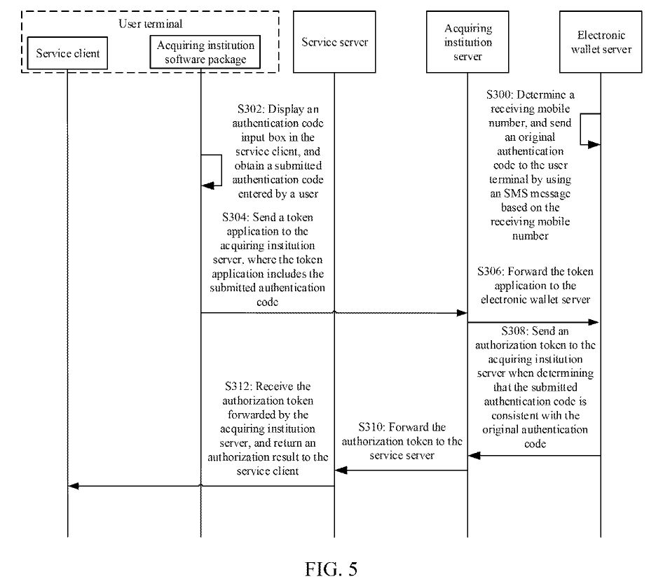

FIG. 5 is a diagram of an interaction procedure of intra-end authorization according to this specification. The following describes specific steps of an intra-end authorization manner based on FIG. 5.

When the electronic wallet server determines that the risk level is less than the preset level, an authorization procedure shown in S300 to S306 is executed.

S300: The electronic wallet server determines a receiving mobile number, and sends an original authentication code to the user terminal by using an SMS message based on the receiving mobile number.

In step S208, if the electronic wallet server determines the risk level based on the first matching degree, the electronic wallet server can use the target account as the second authorization account.

If the electronic wallet server determines the risk level based on the second matching degree, when the reference account includes one electronic wallet account, the reference account serves as the second authorization account. When the reference account includes a plurality of electronic wallet accounts, the electronic wallet server uses, as the second authorization account, an electronic wallet account with a maximum occurrence frequency in the reference account, namely, an electronic wallet account that is historically logged in to most frequently in the current device.

After the second authorization account is determined, each piece of user attribute information of the second authorization account is determined in the user data of the electronic wallet. An attribute value of the user attribute when the user attribute is a mobile number, namely, the receiving mobile number is queried in each piece of user attribute information of the second authorization account.

The electronic wallet server sends the original authentication code to the user terminal by using the SMS message based on the determined receiving mobile number.

S302: The acquiring institution software package displays an authentication code input box in the service client, and obtains a submitted authentication code entered by the user.

In the intra-end authorization manner shown in FIG. 5, the authentication code is collected by the acquiring institution software package, and the acquiring institution software package is integrated into the service client. All authentication pages for collecting the authentication information can be displayed inside the service client by using the acquiring institution software package. There is no a need to jump to the electronic wallet client and display the authentication pages by using the electronic wallet.

The acquiring institution software package displays the authentication page in the service client. The authentication page includes the authentication code input box, to obtain the submitted authentication code entered by the user.

S304: The acquiring institution software package sends a token application to the acquiring institution server, where the token application includes the submitted authentication code.

After collecting the submitted authentication code, the acquiring institution software sends the token application to the electronic wallet server. The token application includes the submitted authentication code. The acquiring institution software package first sends the token application to the acquiring institution server, and then the acquiring institution server sends the token application to the electronic wallet server.

An SMS message authentication code is a one-time valid password, and does not involve identity information of the user. Even if the SMS message authentication code is collected by using the acquiring institution software package, privacy information related to the electronic wallet account of the user is not disclosed.

To further ensure security of an execution process of the authorization procedure, the authentication code herein can have a time limit attribute. Timing starts from a time at which the electronic wallet server sends the original authentication code. If the electronic wallet server does not receive, within a validity time, the submitted authentication code sent by the acquiring institution software package, the authorization procedure is terminated. Alternatively, the authentication code is sent to the receiving mobile number again in response to a request of the user to continue authorization.

Usually, the mobile number serves as registration credential information of a registration account. That is, there is a one-to-one relationship between the mobile number and the electronic wallet account. One mobile number can be used for registration of only one electronic wallet account. Therefore, the user can determine, based on the receiving mobile number, the second authorization account to be bound to the authorization service. Therefore, in this step, the acquiring institution software package does not display the authorization information to the user on the authentication page.

S306: The acquiring institution server forwards the token application to the electronic wallet server.

S308: The electronic wallet server sends the authorization token to the acquiring institution server when determining that the submitted authentication code is consistent with the original authentication code.

The electronic wallet server authenticates a user identity based on the submitted authentication code entered by the user; compares the submitted authentication code with the original authentication code; and if the submitted authentication code is consistent with the original authentication code, can determine that identity authentication succeeds, and send the authorization token to the acquiring institution server.

The electronic wallet server can simultaneously perform identity authentication on the acquiring institution server and the user based on the submitted authentication code in the token application. After the authentication succeeds, the electronic wallet server sends the authorization token to the acquiring institution server.

S310: The acquiring institution server forwards the access token to the service server.

S312: The service server receives the authorization token forwarded by the acquiring institution server, and returns the authorization result to the service client.

The acquiring institution server obtains the authorization token sent by the electronic wallet server, which represents that the authorization result of the authorization service is a success. The acquiring institution server sends the obtained authorization token to the service server. The authorization token is a credential indicating that the service server obtains authorization from the user.

When the user initiates the order payment request in the service client, the service client sends the order payment request to the service server, and the service server can send a deduction request to the electronic wallet server by using the deduction request to carry the authorization token.

After the service server receives the authorization token, a background interaction procedure of the authorization service is successfully completed. The service server sends the authorization result to the service client, and the service client displays the authorization result to the user.

In one or more embodiments of this specification, for better user experience, the authentication page displayed by the acquiring institution software package in step S304 can also include the authorization information.

In step S300, after determining the second authorization account, the electronic wallet server determines the authorization information based on the first authorization account and the second authorization account. The electronic wallet server sends the authorization information to the acquiring institution software package through the acquiring institution server, so that the acquiring institution software package can render the authentication page based on the authorization information.

Similar to the authentication page in step S104, the authentication page herein can also be set to one or more pages for display based on an actual situation.

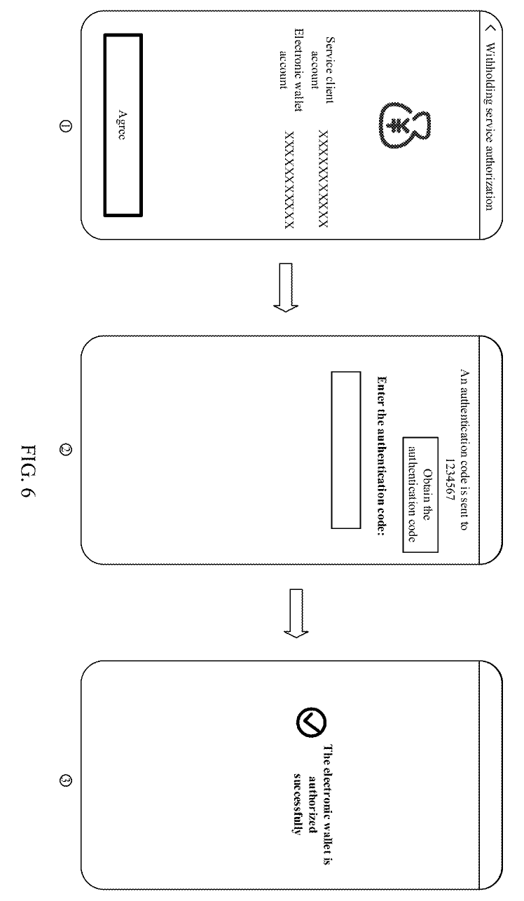

FIG. 6 is a diagram of a page display process existing when a risk level is less than a preset level according to an embodiment of this specification. The process shown in FIG. 6 includes a total of three pages: a page ① to a page ③. The three pages are all pages displayed by the service client, and no jump between clients occurs in an entire procedure of the authorization service.

As shown in FIG. 6, after the user initiates the authorization request in the service client, when the authorization system performs steps S200 to S208 to determine that the risk level is less than the preset level, the authorization system executes the authorization procedure corresponding to the low risk based on steps of S300 to S312. The service client displays the page ①. This page is the first authentication page, and the authorization information is displayed to the user, to request the user to determine whether to bind the first authorization account of the service client and the second authorization account of the electronic wallet. If the user agrees to bind the first authorization account of the service client and the second authorization account of the electronic wallet, the electronic wallet client displays the page ②. This page is the second authentication page, and the user is notified to enter the SMS message authentication code. After obtaining the submitted authentication code entered by the user, the acquiring institution software package sends the token application to the acquiring institution server. The electronic wallet server interacts with the acquiring institution server based on steps S306 to S308. The acquiring institution server obtains the authorization token provided by the electronic wallet server, and authorization succeeds. The acquiring institution server sends the authorization result to the acquiring institution software package. The acquiring institution software package displays the page ③ in the service client, to notify the user of the authorization result.

Clearly, a smaller quantity of pages are displayed in an authorization procedure shown in FIG. 6 than an authorization procedure shown in FIG. 4. There is no jump between clients, and user experience is better.

Regardless of whether the pull-end authorization manner described in S102 to S112 or the intra-end authorization manner described in S300 to S312 is used, the user identity needs to be authenticated by the electronic wallet server. The electronic wallet server stores all user information related to the second authorization account. To be specific, all submitted authentication codes or submitted authentication information entered by the user needs to be finally sent to the electronic wallet server, and the electronic wallet server performs comparison authentication.

When the risk level is not less than the preset level, the authorization system uses the pull-end authorization manner, and the submitted authentication information entered by the user is collected by the electronic wallet client, and then sent to the electronic wallet server. A transmission process is performed only one time. When the risk level is less than the preset level, the authorization system uses the intra-end authorization manner. The submitted authentication code entered by the user is collected by the acquiring institution software package. The acquiring institution software package first sends the submitted authentication code to the acquiring institution server, and then the acquiring institution server sends the submitted authentication code to an electronic wallet server. A transmission process is performed two times, increasing a risk of data leakage during transmission.

Therefore, security of the pull-end authorization manner is higher than that of the intra-end authorization manner. However, an authorization procedure in the intra-end authorization manner is simple, and can improve user experience and accelerate execution efficiency of the authorization service. To better combine advantages of the two authorization manners and ensure security of the authorization service, in the system provided in this specification, the electronic wallet server first needs to determine the risk level of the authorization request; execute the authorization procedure corresponding to the low risk in the intra-end authorization manner when determining that the risk level is less than the preset level, and execute the authorization procedure corresponding to the high risk in the pull-end authorization manner when determining that the risk level is not less than the preset level.

In one or more embodiments of this specification, to further ensure security of the authorization service, the electronic wallet server can first determine a risk score of the authorization request, and determine different identity authentication methods based on different risk scores, so that the authorization procedure is more diversified. An optional authentication method can be password authentication, SMS message authentication, fingerprint authentication, facial recognition authentication, etc. The electronic wallet server can select any one of the optional authentication methods based on a specific authorization service scenario, to perform identity authentication on the user. In addition, in one authorization service, the electronic wallet server can further simultaneously perform multi-factor authentication on the user in a plurality of authentication methods. That is, an authentication method finally determined by the electronic wallet is a combination of the plurality of authentication methods.

Based on this, in step S208, the electronic wallet server determines the risk score of the authorization request based on risk data.

Based on the risk score, the risk level can be further divided. Corresponding to different embodiments in which the risk level is determined in S208, the risk score is also correspondingly determined in different manners.

If the electronic wallet server determines the risk level based on the first matching degree, the first matching degree can be used as the risk score. If the electronic wallet server determines the risk level based on the second matching degree, the second matching degree can be used as the risk score. If the electronic wallet server determines the risk level based on the first matching degree and the second matching degree, the risk score can be determined based on a weighted sum of the first matching degree and the second matching degree, and a specific weight coefficient of the first matching degree and the second matching degree can be set based on an actual authorization scenario. A lower risk score indicates a higher risk level.

The electronic wallet server can divide a value of a total score into a plurality of score intervals, and divide each score interval into a plurality of sub-intervals. Herein, the score interval and the sub-interval can be evenly divided or can be unevenly divided. Therefore, quantities of sub-intervals included in different score intervals are not necessarily the same.

Each score interval corresponds to one risk level, and each sub-interval corresponds to one authentication method. After obtaining the risk score, the electronic wallet server can determine the risk level based on a score interval of the risk score, and determine the authentication method based on the sub-interval including the risk score in the score interval.

After the authorization procedure is determined, an authentication method of the authorization procedure can be further determined based on the risk score. Therefore, there may be different authentication methods in the same authorization procedure, and the authorization procedure is more diversified based on different risk scores. For different risk levels of the high risk, different authorization procedures of the pull-end authorization manner may be executed because of different authentication manners, and for different risk levels of the low risk, different authorization procedures of the intra-end authorization manner may be executed because of different authentication manners

Then, the electronic wallet server sends the risk score to the acquiring institution software package, so that the acquiring institution software package determines the risk level and the authentication method. Different authentication information need to be collected for different authentication methods, and different authentication pages are corresponding displayed.

When the acquiring institution software package determines that the risk level is less than the preset level, the authorization procedure corresponding to the low risk is executed. The authentication page corresponding to the authentication method is displayed, to notify the user to enter the authentication information, and obtain the submitted authentication information corresponding to the authentication method entered by the user. The token application is sent to the electronic wallet server through the acquiring institution server, and the token application includes the submitted authentication information.

Then, the electronic wallet server cooperates with the acquiring institution server to execute the authorization service based on similar steps of S304 to S312. A difference lies in that if the authentication method used in S302 is SMS message authentication, the submitted authentication information in S302 is the submitted authentication code. In this embodiment, the token application includes the submitted authentication information, and the submitted authentication information needs to correspond to the authentication method. For example, when password authentication is performed, the submitted authentication information is a payment password corresponding to the second authorization account.

When the acquiring institution software package determines that the risk level is not less than the preset level, the authorization procedure corresponding to the high risk is executed. The acquiring institution software package sends an invoking request to the electronic wallet client, to invoke the electronic wallet client. The invoking request includes the authentication method, so that the electronic wallet client displays a corresponding authentication page based on the authentication method, and obtains the submitted authentication information entered by the user.

The electronic wallet client cooperates with the electronic wallet server and the acquiring institution server to execute the authorization service based on the steps S104~S112.

In this embodiment, the authentication method for the risk level corresponding to the high risk can be the same as or different from the authentication method for the risk level corresponding to the low risk. For example, both the authentication method for the risk level corresponding to the high risk and the authentication method for the risk level corresponding to the high risk can include SMS message authentication. The user identity is authenticated by using the authentication code, and only when it is determined that the risk level has a high risk, the electronic wallet client displays the authentication page to obtain submitted authentication information. When determining that the risk level is a low risk, the acquiring institution software package displays the authentication page and obtains the submitted authentication information.

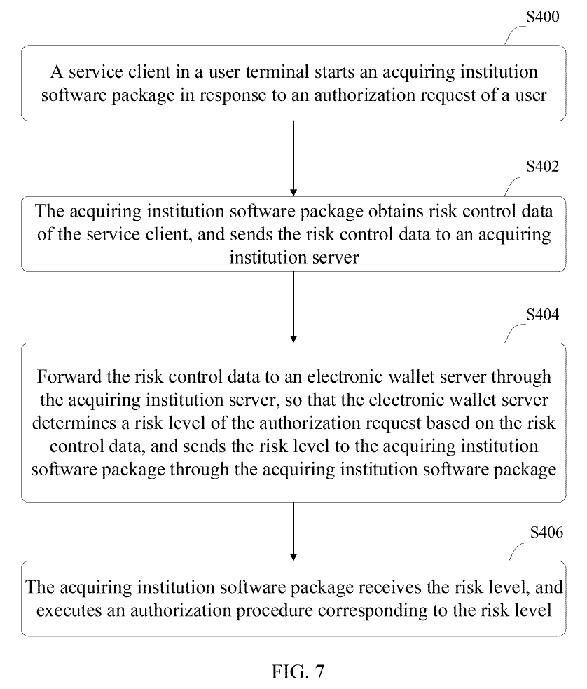

This specification further provides an authorization method corresponding to the authorization system in FIG. 3, as shown in FIG. 7.

FIG. 7 is a schematic flowchart of an authorization method according to this specification. The authorization method shown in FIG. 7 is applied to a user terminal in an authorization system. The authorization system includes the user terminal, an acquiring institution server, and an electronic wallet server. A service client is installed in the user terminal. The service client includes an acquiring institution software package. The method includes the following steps.

S400: The service client in the user terminal starts the acquiring institution software package in response to an authorization request of a user.

S402: The acquiring institution software package obtains risk control data of the service client, and sends the risk control data to the acquiring institution server.

S404: Forward the risk control data to the electronic wallet server through the acquiring institution server, so that the electronic wallet server determines a risk level of the authorization request based on the risk control data, and sends the risk level to the acquiring institution software package through the acquiring institution server.

S406: The acquiring institution software package receives the risk level, and executes an authorization procedure corresponding to the risk level.

For specific content of steps S400 to S406 corresponding to FIG. 7, refer to the above-mentioned descriptions of corresponding content in FIG. 3. Details are not described herein again in this specification.

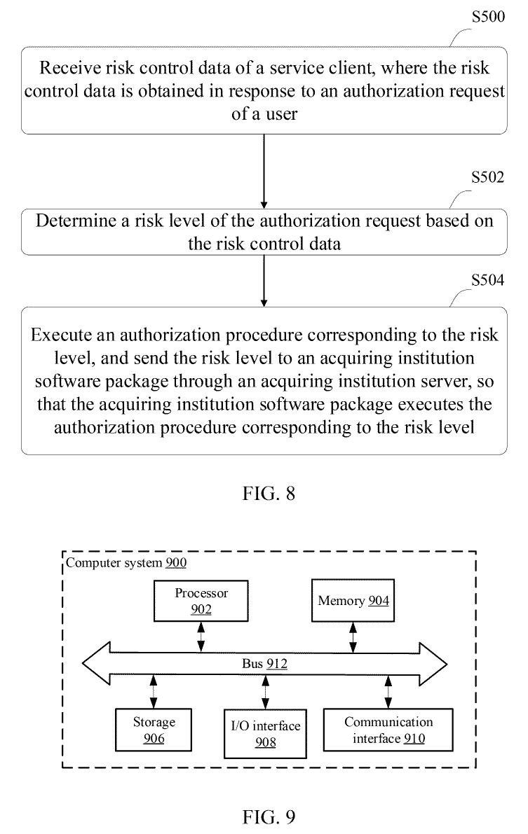

This specification further provides another authorization method corresponding to the authorization system in FIG. 3, as shown in FIG. 8.

FIG. 8 is a schematic flowchart of an authorization method according to this specification. The authorization method shown in FIG. 8 is applied to an electronic wallet server in an authorization system. The authorization system includes a user terminal, an acquiring institution server, and the electronic wallet server. A service client is installed in the user terminal. The service client includes an acquiring institution software package. The method includes the following steps.

S500: Receive risk control data of the service client, where the risk control data is obtained in response to an authorization request of a user.

S502: Determine a risk level of the authorization request based on the risk control data.

S504: Execute an authorization procedure corresponding to the risk level, and send the risk level to the acquiring institution software package through the acquiring institution server, so that the acquiring institution software package executes an authorization procedure corresponding to the risk level.

Similarly, for specific content of steps S500 to S504 corresponding to FIG. 8, refer to the above-mentioned descriptions of corresponding content in FIG. 3. Details are not described herein again in this specification.

The specification also provides a computer-readable non-transitory storage medium, where the storage medium stores a computer program, which, when executed by a processor, can be used to perform one or more steps of one or more methods described or illustrated herein or provides functionality described or illustrated herein. Herein, the computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The specification also provides a computer system. FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLB s). Instructions in the instruction caches may be copies of instructions in memory 904 or storage 906, and the instruction caches may speed up retrieval of those instructions by processor 902. Data in the data caches may be copies of data of instructions in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

For ease of description, the above-mentioned apparatus is described by dividing the apparatus into various modules based on functions. Certainly, during implementation of this specification, functions of all modules can be implemented in one or more pieces of software and/or hardware.

The above-mentioned descriptions are merely embodiments of this specification, and are not intended to limit this specification. A person skilled in the art can make various changes and changes to this specification. Any modification, equivalent replacement, improvement, etc. made without departing from the spirit and principle of this specification shall fall within the scope of the claims in this application.

What is claimed is:

1. A computer-implemented method for authorization, comprising:
starting, by a service client in a user terminal in an authorization system, an acquiring institution software package in response to an authorization request of a user, wherein the authorization system comprises the user terminal, an acquiring institution server, and an electronic wallet server, wherein the service client is installed in the user terminal, and wherein the service client comprises the acquiring institution software package;
obtaining, by the acquiring institution software package, risk control data of the service client;
sending the risk control data to the electronic wallet server through the acquiring institution server, wherein the electronic wallet server determines a risk level of the authorization request based on the risk control data and sends the risk level to the acquiring institution software package through the acquiring institution server;
receiving, by the acquiring institution software package, the risk level; and
executing an authorization procedure corresponding to the risk level.

2. The computer-implemented method of claim 1, wherein, when the risk level is less than a preset level, the executing an authorization procedure corresponding to the risk level, comprises:
receiving an original authentication code sent by the electronic wallet server by using an SMS message;
displaying, by the acquiring institution software package, an authentication code input box in the service client;
obtaining a submitted authentication code entered by the user;
sending a token application to the electronic wallet server through the acquiring institution server, wherein the token application comprises the submitted authentication code, so that the electronic wallet server determines whether the submitted authentication code is consistent with the original authentication code; and
receiving, by the service client, an authorization result of the electronic wallet server.

3. The computer-implemented method of claim 1, wherein:
an electronic wallet client is further installed in the user terminal; and
when the risk level is not less than a preset level, the executing an authorization procedure corresponding to the risk level comprises:
invoking, by the acquiring institution software package, the electronic wallet client;
displaying, by the electronic wallet client, an authentication page, to notify the user of authorization information, and notify the user to enter authentication information;
obtaining, by the electronic wallet client, submitted authentication information entered by the user;
sending the submitted authentication information to the electronic wallet server, so that the electronic wallet server performs identity authentication based on the submitted authentication information; and
receiving, by the service client, an authorization result of the electronic wallet server.

4. The computer-implemented method of claim 1, wherein, when the risk level is less than a preset level:
receiving, by the acquiring institution software package, a risk score sent by the electronic wallet server;
determining the risk level and an authentication method, wherein the risk score is determined by the electronic wallet server based on the risk control data, and the authentication method is at least one of password authentication, SMS message authentication, fingerprint authentication, and facial recognition authentication;
displaying, by the acquiring institution software package, an authentication page corresponding to the authentication method, to notify the user to enter authentication information;
obtaining submitted authentication information that corresponds to the authentication method and that is entered by the user;
sending, by the acquiring institution software package, a token application to the electronic wallet server through the acquiring institution server, wherein the token application comprises the submitted authentication information, so that the electronic wallet server determines whether the submitted authentication information is consistent with original authentication information corresponding to the authentication method; and
receiving, by the service client, an authorization result of the electronic wallet server.

5. The computer-implemented method of claim 4, wherein:
an electronic wallet client is further installed in the user terminal; and
when the risk level is not less than the preset level:
invoking, by the acquiring institution software package, the electronic wallet client.

6. The computer-implemented method of claim 5, wherein, when the risk level is not less than the preset level:
displaying, by the electronic wallet client, an authentication page corresponding to the authentication method, to notify the user of authorization information, and notify the user to enter authentication information.

7. The computer-implemented method of claim 6, wherein when the risk level is not less than the preset level:
obtaining, by the electronic wallet client, the submitted authentication information that corresponds to the authentication method and that is entered by the user;
sending the submitted authentication information to the electronic wallet server, so that the electronic wallet server determines whether the submitted authentication information is consistent with original authentication information corresponding to the authentication method; and
receiving, by the service client, the authorization result of the electronic wallet server.

8. A non-transitory, computer-readable medium storing one or more instructions executable by a computer system to perform one or more operations for authorization, comprising:
starting, by a service client in a user terminal in an authorization system, an acquiring institution software package in response to an authorization request of a user, wherein the authorization system comprises the user terminal, an acquiring institution server, and an electronic wallet server, wherein the service client is installed in the user terminal, and wherein the service client comprises the acquiring institution software package;
obtaining, by the acquiring institution software package, risk control data of the service client;
sending the risk control data to the electronic wallet server through the acquiring institution server, wherein the electronic wallet server determines a risk level of the authorization request based on the risk control data and sends the risk level to the acquiring institution software package through the acquiring institution server;
receiving, by the acquiring institution software package, the risk level; and
executing an authorization procedure corresponding to the risk level.

9. The non-transitory, computer-readable medium of claim 8, wherein, when the risk level is less than a preset level, the executing an authorization procedure corresponding to the risk level, comprises:
receiving an original authentication code sent by the electronic wallet server by using an SMS message;
displaying, by the acquiring institution software package, an authentication code input box in the service client;
obtaining a submitted authentication code entered by the user;
sending a token application to the electronic wallet server through the acquiring institution server, wherein the token application comprises the submitted authentication code, so that the electronic wallet server determines whether the submitted authentication code is consistent with the original authentication code; and
receiving, by the service client, an authorization result of the electronic wallet server.

10. The non-transitory, computer-readable medium of claim 8, wherein:
an electronic wallet client is further installed in the user terminal; and
when the risk level is not less than a preset level, the executing an authorization procedure corresponding to the risk level comprises:
invoking, by the acquiring institution software package, the electronic wallet client;
displaying, by the electronic wallet client, an authentication page, to notify the user of authorization information, and notify the user to enter authentication information;
obtaining, by the electronic wallet client, submitted authentication information entered by the user;
sending the submitted authentication information to the electronic wallet server, so that the electronic wallet server performs identity authentication based on the submitted authentication information; and
receiving, by the service client, an authorization result of the electronic wallet server.

11. The non-transitory, computer-readable medium of claim 8, wherein, when the risk level is less than a preset level:
receiving, by the acquiring institution software package, a risk score sent by the electronic wallet server;
determining the risk level and an authentication method, wherein the risk score is determined by the electronic wallet server based on the risk control data, and the authentication method is at least one of password authentication, SMS message authentication, fingerprint authentication, and facial recognition authentication;
displaying, by the acquiring institution software package, an authentication page corresponding to the authentication method, to notify the user to enter authentication information;
obtaining submitted authentication information that corresponds to the authentication method and that is entered by the user;
sending, by the acquiring institution software package, a token application to the electronic wallet server through the acquiring institution server, wherein the token application comprises the submitted authentication information, so that the electronic wallet server determines whether the submitted authentication information is consistent with original authentication information corresponding to the authentication method; and
receiving, by the service client, an authorization result of the electronic wallet server.

12. The non-transitory, computer-readable medium of claim 11, wherein:
an electronic wallet client is further installed in the user terminal; and
when the risk level is not less than the preset level:
invoking, by the acquiring institution software package, the electronic wallet client.

13. The non-transitory, computer-readable medium of claim 12, wherein, when the risk level is not less than the preset level:
displaying, by the electronic wallet client, an authentication page corresponding to the authentication method, to notify the user of authorization information, and notify the user to enter authentication information.

14. The non-transitory, computer-readable medium of claim 13, wherein when the risk level is not less than the preset level:
obtaining, by the electronic wallet client, the submitted authentication information that corresponds to the authentication method and that is entered by the user;
sending the submitted authentication information to the electronic wallet server, so that the electronic wallet server determines whether the submitted authentication information is consistent with original authentication information corresponding to the authentication method; and
receiving, by the service client, the authorization result of the electronic wallet server.

15. A computer-implemented system for authorization, comprising:
one or more computers; and
one or more computer memory devices interoperably coupled with the one or more computers and having tangible, non-transitory, machine-readable media storing one or more instructions that, when executed by the one or more computers, perform one or more operations, comprising:
starting, by a service client in a user terminal in an authorization system, an acquiring institution software package in response to an authorization request of a user, wherein the authorization system comprises the user terminal, an acquiring institution server, and an electronic wallet server, wherein the service client is installed in the user terminal, and wherein the service client comprises the acquiring institution software package;
obtaining, by the acquiring institution software package, risk control data of the service client;
sending the risk control data to the electronic wallet server through the acquiring institution server, wherein the electronic wallet server determines a risk level of the authorization request based on the risk control data and sends the risk level to the acquiring institution software package through the acquiring institution server;
receiving, by the acquiring institution software package, the risk level; and
executing an authorization procedure corresponding to the risk level.

16. The computer-implemented system of claim 15, wherein, when the risk level is less than a preset level, the executing an authorization procedure corresponding to the risk level, comprises:
receiving an original authentication code sent by the electronic wallet server by using an SMS message;
displaying, by the acquiring institution software package, an authentication code input box in the service client;
obtaining a submitted authentication code entered by the user;
sending a token application to the electronic wallet server through the acquiring institution server, wherein the token application comprises the submitted authentication code, so that the electronic wallet server determines whether the submitted authentication code is consistent with the original authentication code; and
receiving, by the service client, an authorization result of the electronic wallet server.

17. The computer-implemented system of claim 15, wherein:
an electronic wallet client is further installed in the user terminal; and
when the risk level is not less than a preset level, the executing an authorization procedure corresponding to the risk level comprises:
invoking, by the acquiring institution software package, the electronic wallet client;
displaying, by the electronic wallet client, an authentication page, to notify the user of authorization information, and notify the user to enter authentication information;
obtaining, by the electronic wallet client, submitted authentication information entered by the user;
sending the submitted authentication information to the electronic wallet server, so that the electronic wallet server performs identity authentication based on the submitted authentication information; and
receiving, by the service client, an authorization result of the electronic wallet server.

18. The computer-implemented system of claim 15, wherein, when the risk level is less than a preset level:
receiving, by the acquiring institution software package, a risk score sent by the electronic wallet server;
determining the risk level and an authentication method, wherein the risk score is determined by the electronic wallet server based on the risk control data, and the authentication method is at least one of password authentication, SMS message authentication, fingerprint authentication, and facial recognition authentication;
displaying, by the acquiring institution software package, an authentication page corresponding to the authentication method, to notify the user to enter authentication information;
obtaining submitted authentication information that corresponds to the authentication method and that is entered by the user;
sending, by the acquiring institution software package, a token application to the electronic wallet server through the acquiring institution server, wherein the token application comprises the submitted authentication information, so that the electronic wallet server determines whether the submitted authentication information is consistent with original authentication information corresponding to the authentication method; and
receiving, by the service client, an authorization result of the electronic wallet server.

19. The computer-implemented system of claim 18, wherein:
an electronic wallet client is further installed in the user terminal; and
when the risk level is not less than the preset level:
invoking, by the acquiring institution software package, the electronic wallet client.

20. The computer-implemented system of claim 19, wherein, when the risk level is not less than the preset level:
displaying, by the electronic wallet client, an authentication page corresponding to the authentication method, to notify the user of authorization information, and notify the user to enter authentication information.
